(19) United States
(12) Patent Application Publication
(10) Pub. No.: US 2025/0285448 A1
(43) Pub. Date: Sep. 11, 2025

(54) ELECTRONIC DEVICE, METHOD, AND NON-TRANSITORY COMPUTER READABLE STORAGE MEDIUM FOR ESTIMATING LENGTH OF TRAILER USING CAMERA

(71) Applicant: THINKWARE CORPORATION, Seongnam-si (KR)

(72) Inventors: Haejun JUNG, Seongnam-si (KR); Yosep PARK, Seongnam-si (KR)

(21) Appl. No.: 19/070,595

(22) Filed: Mar. 5, 2025

(30) Foreign Application Priority Data
Mar. 5, 2024 (KR) 10-2024-0031639

(51) Int. Cl. G06V 20/58; G06T 7/60; G06V 10/82; G06V 20/56

(52) U.S. Cl. CPC G06V 20/58; G06T 7/60; G06V 10/82; G06V 20/588; G06T 2207/10016; G06T 2207/20084; G06T 2207/30252; G06V 2201/08

(57) ABSTRACT

In an embodiment, an electronic device of a vehicle including a tractor for towing a trailer includes a communication interface, a processor, and the processor is configured to obtain, through the communication interface, an image of a camera viewing toward a rear direction of the tractor from underneath the trailer, wherein the camera is disposed at a rear portion of the tractor, identify, within the image, a first portion covered by the trailer and a second portion not covered by the trailer, and based on a size of the second portion, determine a length of the trailer.

### CROSS-REFERENCE TO RELATED APPLICATION(S)

This application is based on and claims priority under 35 U.S.C. § 119 to Korean Patent Application No. 10-2024-0031639, filed on Mar. 5, 2024, in the Korean Intellectual Property Office, the disclosure of which is incorporated by reference herein in its entirety.

### BACKGROUND

### Technical Field

The present disclosure relates to an electronic device, a method, and a non-transitory computer readable storage medium for estimating a length of a trailer using a camera.

### Description of Related Art

A vehicle such as a tractor for towing a trailer may include an electronic component such as an electronic control unit (ECU) to assist a driving activity of a driver. The electronic component may include a camera for obtaining an image and/or a video of an external environment of the vehicle.

The above-described information may be provided as a related art for the purpose of helping understanding of the present disclosure. No argument or decision is made as to whether any of the above description may be applied as a prior art related to the present disclosure.

### SUMMARY

In an embodiment, an electronic device of a vehicle including a tractor for towing a trailer may comprise a communication interface, and a processor, and the processor may be configured to obtain, through the communication interface, an image of a camera viewing toward a rear direction of the tractor from underneath the trailer, wherein the camera is disposed at a rear portion of the tractor, identify, within the image, a first portion covered by the trailer and a second portion not covered by the trailer, and based on a size of the second portion, determine a length of the trailer.

According to an embodiment, a method of an electronic device of a vehicle including a tractor for towing a trailer may comprise obtaining an image of a camera viewing toward a rear direction of the tractor from underneath the trailer, wherein the camera is disposed at a rear portion of the tractor, identifying, within the image, a first portion covered by the trailer and a second portion not covered by the trailer, and based on a size of the second portion, determining a length of the trailer.

According to an embodiment, a non-transitory computer-readable storage medium may store one or more programs. The one or more programs, when executed by a processor of an electronic device of a vehicle including a tractor for towing a trailer, may cause the electronic device to obtain an image of a camera viewing toward a rear direction of the tractor from underneath the trailer, wherein the camera is disposed at a rear portion of the tractor, identify, within the image, a first portion covered by the trailer and a second portion not covered by the trailer, and based on a size of the second portion, determine a length of the trailer.

### BRIEF DESCRIPTION OF THE DRAWINGS

FIGS. 1A, 1B, and 1C illustrate an example of a vehicle including an electronic device 201 according to an embodiment.

FIG. 2 illustrates a block diagram of an electronic device 201 according to an embodiment.

FIGS. 3A and 3B are diagrams for describing an operation of an electronic device for determining a length of a trailer 120 according to an embodiment.

FIGS. 4A and 4B are diagrams for describing a method of determining a size of a second portion of an image, according to an embodiment.

FIGS. 5A and 5B are diagrams for describing a method of determining a distance to another vehicle located in a rear direction of a vehicle according to an embodiment.

FIG. 6 illustrates a flowchart for an electronic device according to an embodiment.

FIG. 7 illustrates an example of a block diagram illustrating an autonomous driving system of a vehicle according to an embodiment.

FIGS. 8 and 9 illustrate an example of a block diagram illustrating an autonomous driving moving object according to an embodiment.

FIG. 10 illustrates an example of a gateway associated with a user device according to various embodiments.

FIG. 11 is a diagram for describing an operation of an electronic device for training a neural network based on a set of learning data according to an embodiment.

FIG. 12 is a block diagram of an electronic device according to an embodiment.

### DETAILED DESCRIPTION

Specific structural or functional descriptions of embodiments according to a concept of the present invention disclosed in the present specification are illustrated only for a purpose of describing the embodiments according to the concept of the present invention, and the embodiments according to the concept of the present invention may be implemented in various forms and are not limited to embodiments described in the present specification.

Since the embodiments according to the concept of the present invention may apply various changes and have various forms, the embodiments will be illustrated in the drawings and described in detail in the present specification. However, this is not intended to limit the embodiments according to the concept of the present invention to specific disclosure forms, and includes modifications, equivalents, or substitutes included in a spirit and technical scope of the present invention.

Although terms such as first or second may be used to describe various components, the components should not be limited by the terms. The terms are only for a purpose of distinguishing one component from another component, for example, without departing from a scope of rights according to the concept of the present invention, a first component may be referred to as a second component, and similarly the second component may also be referred to as the first component.

When a component is said to be “connected” or “accessed” to another component, it should be understood that it may be directly connected or accessed to the other component, but another component may exist in a middle. On the other hand, when a component is said to be “directly connected” or “directly connected” to another component, it should be understood that no other component exists in the middle. Expressions that describe a relationship between components, such as “between” and “directly between” or “directly adjacent to”, should be interpreted in the same way.

A term used in the present specification is used only to describe specific embodiments and is not intended to limit the present invention. Singular expressions include plural expressions unless context clearly indicates otherwise. In the present specification, a term such as “include” or “have”, and the like is intended to be designated as existence of a described feature, number, step, operation, component, part, or a combination thereof, and should be understood not to preclude a probability of the existence or addition of one or more other features, numbers, steps, operations, components, parts, or a combination thereof.

Unless otherwise defined, all terms used herein, including technical or scientific terms, have the same meaning as commonly understood by a person of ordinary skill in the art to which the present invention belongs. Terms defined in commonly used dictionaries should be interpreted as having a meaning consistent with the meaning of the context of relevant technology, and are not interpreted in an ideal or overly formal sense unless explicitly defined herein.

Hereinafter, embodiments will be described in detail with reference to the accompanying drawings. However, a scope of a patent application is not limited or restricted by these embodiments. The same reference numerals presented in each drawing may indicate the same configuration, and overlapping descriptions thereof may be omitted.

For many years, a trucking industry has experienced steady growth and has expanded a range of services to respond to more complex supply chains. These services include last-mile deliveries, drop-trailer programs, and intermodal transportation (a transportation type in which freight is carried to a destination by two or more different means of transportation (a ship and a rail, or a ship and an airplane)) at a port.

As such, since there are so many different ways to carry the freight, manufacturers of freight-related equipment have designed different types of equipment to carry the freight according to various transportation needs.

In the present specification, a truck that tows a trailer for a main purpose of a freight carry (or catering) is collectively referred to as a tractor.

The tractor described in the present specification may be classified into a conventional truck (or a bonneted truck), a cab-over truck (or a cab-over engine), and a semi-conventional truck, which is an intermediate form between the conventional truck and the cab-over truck, according to a location and a form of a cab of the tractor.

The conventional truck, which is a form in which an engine and a hood are positioned above a front axle in front of a cab of a tractor, and has a structure in which a driver sits behind the front axle, is a type of a tractor mainly used in North America where the engine of the tractor is located in front of the driver.

On the other hand, the cap over truck, which has a structure in which a cap of a tractor is located to a front end of the tractor and a driver sits in front of a front axle, and is a form a so-called “flat face (or flat nose)” in which a front of the tractor is flat, is a type of a tractor mainly used in most countries, such as Europe and Asia where an engine of the tractor is located under the driver.

Just as there are various forms according to a purpose and a demand of a tractor, there are various forms of trailers towed by the tractor. Among them, the most representative types of trailers are a full-trailer and a semi-trailer. The full trailer and the semi-trailer may be distinguished by whether the trailer is equipped with both a front axle and a rear axle. This trailer may be connected to a box truck or a tractor through a coupling device.

Specifically, the full trailer is a commercial freight trailer equipped with both the front axle and the rear axle. The full trailer may fully support its own weight without relying on a tractor by being to support an entire load only with the trailer, is equipped with a drawbar to be coupled to a towing unit (or a hauling unit) such as the tractor, and is mainly used in the United States and Canada and the like.

On the other hand, the semi-trailer, which is a freight trailer with only a rear axle without a front axle, may support a large portion of a load by a tractor connected by a kind of hitch called a “fifth wheel” ( [symbol] ). In case of being in a stationary state by being detached from the tractor, the semi-trailer may support the load of the trailer by spreading a landing gear mounted on an underneath of the semi-trailer vertically to the ground. A combination of the semi-trailer and the tractor is called a semi-trailer truck (also called simply a “semi-trailer”, a “tractor-trailer”, a “semi-truck”, a “big rig”, or a “semi” in the United States). The above-described “Fifth wheel” refers to a horizontal wheel attached to a tractor axle of a trailer truck to facilitate a direction change of the trailer, and is also called a front turning wheel. The “Fifth wheel” is a device that enables a movable coupling ( [symbol] ) of a tractor and a semi-trailer and includes an underneath consisting of a trunnion plate and a clasp ( [symbol] ) device that firmly fixes a kingpin mounted on the semi-trailer to the tractor.

Hereinafter, in the present specification, based on the terms of the tractors/trailers described above, for convenience of explanation, “trailer” will be used to mean a freight transport vehicle connected to a tractor for a trailer, and “trailer” will be used as a tow vehicle for moving the trailer. In addition, in the present invention, in order to exclude a limitation of rights according to an embodiment described in a detailed description as much as possible, a tractor hauling/towing a “trailer” may be described interchangeably with a term “towing vehicle,” a trailer towed by a tractor may be described interchangeably with a term “towed vehicle”.

Also, for convenience of explanation, it is desirable to understand that the “trailer” described throughout the present specification refers to a “semi-trailer,” but is not limited thereto.

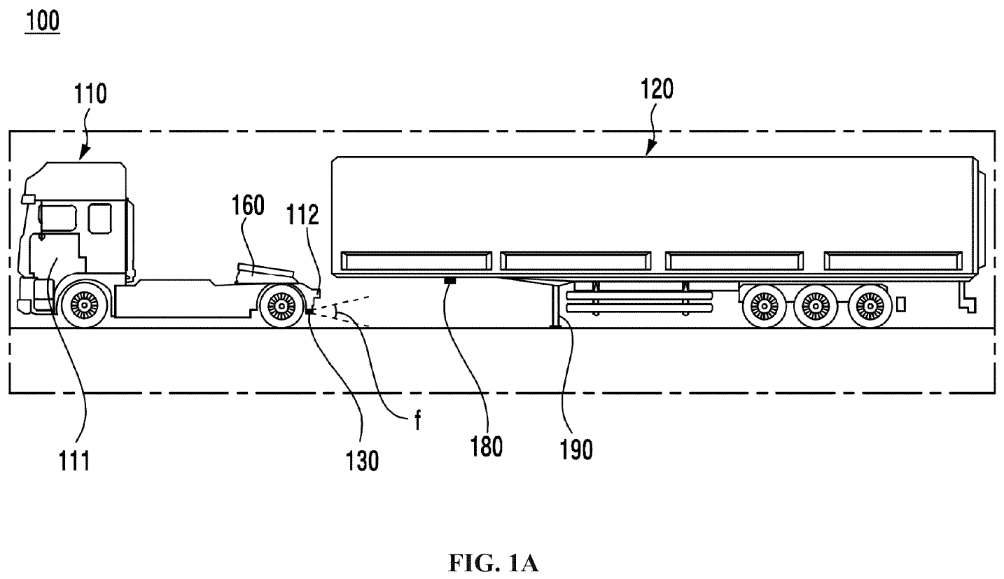

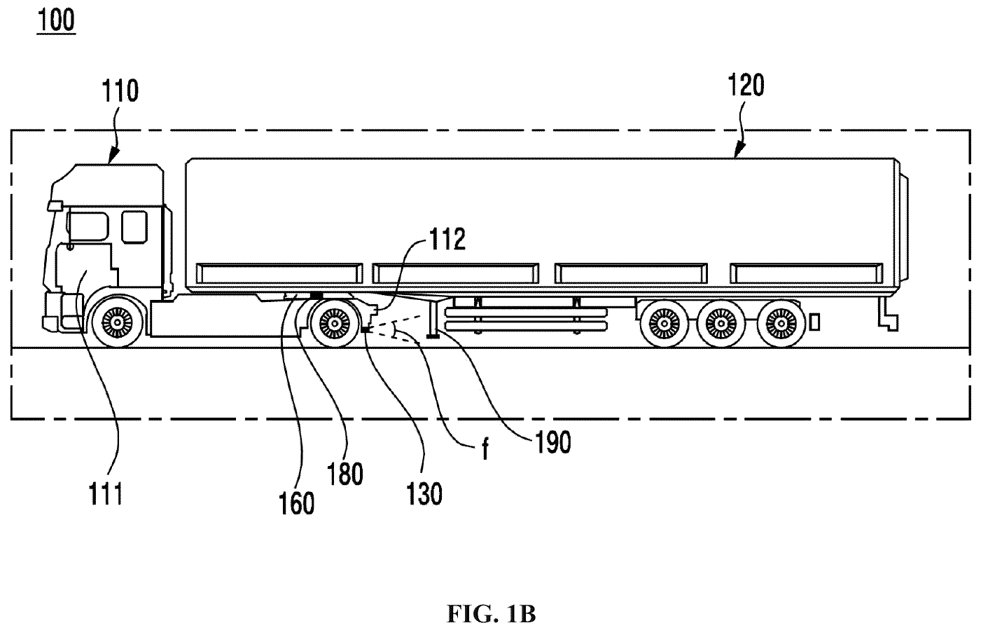

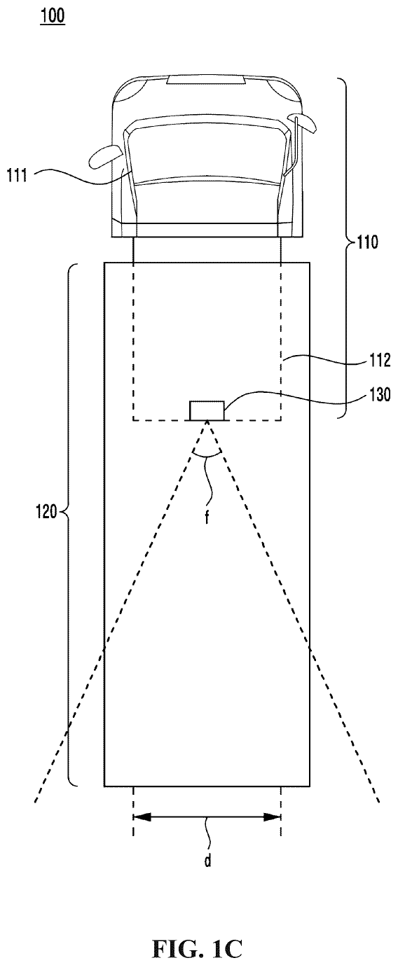

FIGS. 1A, 1B, and 1C illustrate an example of a vehicle including an electronic device 201 according to an embodiment. Referring to FIGS. 1A, 1B, and 1C, a vehicle 100 including a tractor or a tractor unit 110 and a semi-trailer 120 is exemplarily illustrated. FIG. 1A indicates a state in which the tractor 110 and the semi-trailer 120 are not connected, and FIG. 1B indicates a state in which the tractor 110 and the semi-trailer 120 are connected. In an embodiment, the semi-trailer 120 may be selectively connected by a fifth wheel hitch 160 carried by the tractor 110, and the fifth wheel hitch 160 may be fastened to a kingpin 180 fixed to the semi-trailer 120 according to a known manner. The vehicle 100 including the tractor 110 and the semi-trailer 120 may be referred to as a truck. The vehicle 100 may include only the tractor 110.

The semi-trailer 120 illustrated in FIGS. 1A, 1B, and 1C illustrates a form of a “semi-trailer”, but this is for convenience of explanation, and an embodiment of the present disclosure should not be understood to be applied only to the form of the “semi-trailer”. The tractor 110 illustrated in FIGS. 1A, 1B, and 1C illustrates a form of a “cap-over truck,” but this is for convenience of explanation, and an embodiment of the present disclosure should not be understood to be applied only to the form of the “cap-over truck”.

In an embodiment, the tractor 110 may include a forward part 111 and a rear part 112. The forward part 111 may include a cab (or a cabin) on which a driver rides. The fifth wheel hitch 160 to which the semi-trailer 120 is coupled may be disposed in the rear part 112. In an embodiment, the semi-trailer 120 may include the kingpin 180 coupled to the fifth wheel hitch 160 of the tractor 110 and a landing gear 190 supporting the semi-trailer 120 from the ground in a state in which the semi-trailer 120 is not coupled to the tractor 110. The king pin 180 and the landing gear 190 may be installed underneath the semi-trailer 120.

In an embodiment, the tractor 110 may include an internal combustion engine referred to as an engine, a motor, or a combination thereof. The tractor 110 may include a battery and/or a fuel tank (e.g., a fuel tank designed to store gasoline, diesel, liquified natural gas (LNG), liquefied petroleum gas (LPG), and/or hydrogen). For example, the tractor 110, including a rechargeable battery and a motor driven by electrical energy stored in the battery, may be referred to as an electric vehicle (EV) and/or an electric truck. For example, the tractor 110, including the fuel tank and the engine in addition to the battery and the motor, may be referred to as a hybrid vehicle (e.g., a plug-in hybrid electric vehicle (PHEV)).

In an embodiment, the semi-trailer 120 may be coupled or detached with the tractor 110. For example, the semi-trailer 120 may be connected to the rear part 112 of the tractor 110. The semi-trailer 120 coupled to the tractor 110, may be towed by the tractor 110. To support driving on a curved road, the semi-trailer 120 may be rotatably coupled to the tractor 110. For example, the tractor 110 and the semi-trailer 120 may be rotatably coupled through a coupling device including the fifth wheel hitch 160 and the king pin 180. However, a link mechanism between the tractor 110 and the semi-trailer 120 is not limited thereto.

In an embodiment, the semi-trailer 120 may have a structure for accommodating people and/or freight. For example, the semi-trailers 120 may include a trailer for transporting people, such as a trailer bus, a camper van, and a caravan. For example, the semi-trailers 120 may include a trailer for transporting various freight, such as a flat-panel trailer, a container trailer, a dump trailer, a refrigerated trailer, a tank trailer, and an automobile transport trailer. However, it is not limited by the above-described example.

In an embodiment, the vehicle may include a plurality of electronic components. The electronic component included in the vehicle may be referred to as an electronic control unit (ECU). The electronic component may include a sensing means for obtaining and/or detecting information related to the vehicle and/or an external environment of the vehicle, and/or a driving means for controlling the vehicle.

The driving means may include a steering motor for changing a driving direction according to an steering angle of the vehicle, a transmission, an electronic brake that provides braking power according to a movement of a pedal, an anti-lock brake system (ABS) that controls an output of the braking power, and/or an electronic throttle control valve (ETC) that controls an output of an engine according to the movement of the pedal.

The sensing means may include a seat sensor for detecting a person sitting on a seat, one or more temperature sensors for detecting a temperature of air inside and/or outside the vehicle, a global positioning system (GPS) sensor for detecting a geographical location of the vehicle, an inertial measurement unit (IMU) (e.g., an acceleration sensor, a gyro sensor, a geomagnetic sensor, or a combination thereof) for detecting a physical movement (e.g., a translation movement and/or a rotational movement) of the vehicle. An embodiment is not limited thereto, and the sensing means may include a camera, a depth camera, a time of flight (ToF) sensor, a light detection and ranging (LiDAR), a radar, a proximity sensor, and/or an ultrawideband (UWB) sensor as a means for detecting an external object.

In an embodiment, the tractor 110 may include a camera 130 disposed to face a rear direction of the tractor 110. The camera 130 may sequentially output images corresponding to an angle of view f in a time domain. An electronic device of the vehicle may obtain composite images (e.g., a video) based on the images obtained from the cameras in the time domain.

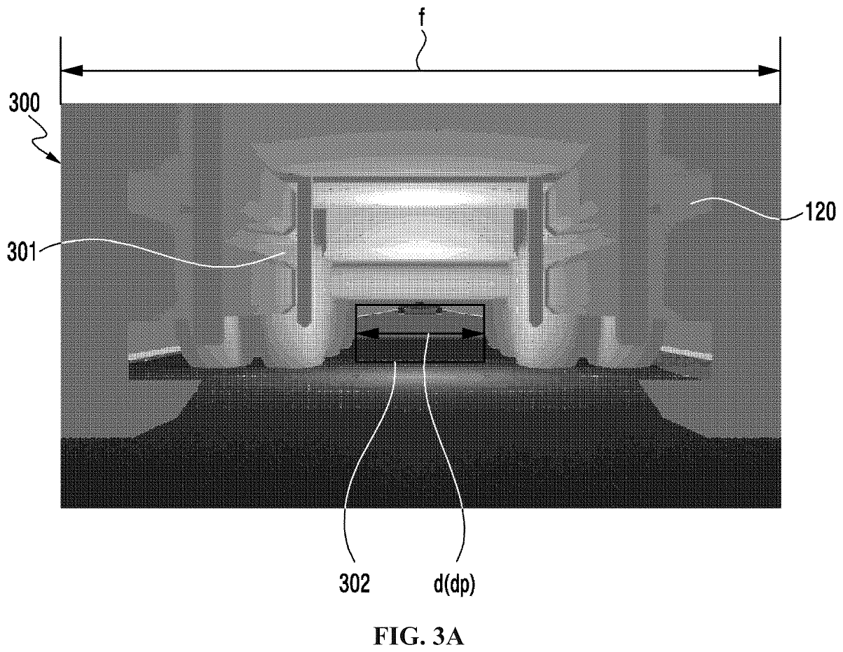

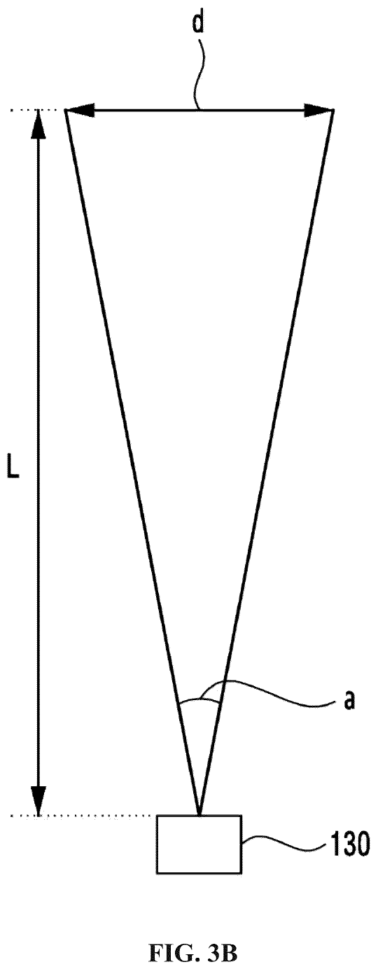

In an embodiment, the camera 130 may be disposed on the rear part 112 of the tractor 110. For example, camera 130 may be disposed at an end of the rear part 112 along the rear direction of the tractor 110. For example, the camera 130 may be located under the rear part 112. In a state in which the semi-trailer 120 is coupled to the tractor 110, the camera 130 may be located under the semi-trailer 120. The camera 130 may obtain an image viewing toward the rear direction of the tractor 110 from under the semi-trailer 120. In an embodiment, the electronic device of the vehicle may determine an actual length d (e.g., an actual length d of a second portion 302 of FIG. 3A) with respect to a rear of the semi-trailer 120 using the image obtained through the camera 130. The electronic device of the vehicle may determine an entire length of the semi-trailer 120 using the actual length d. This will be described with reference to FIGS. 3A to 6.

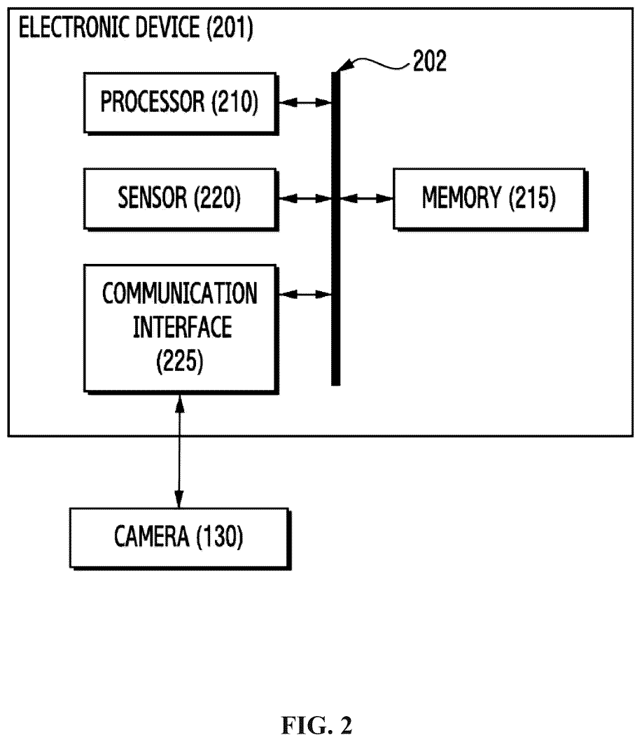

FIG. 2 illustrates a block diagram of an electronic device 201 according to an embodiment. The electronic device 201 according to an embodiment may be included in a vehicle including the tractor 110 described with reference to FIG. 1.

Referring to FIG. 2, the electronic device 201 according to an embodiment may include at least one of a processor 210, memory 215, a sensor 220, and a communication interface 225. The processor 210, the memory 215, the sensor 220, and the communication interface 225 may be electrically and/or operatively connected to each other by a circuit such as a communication bus 202. Hereinafter, circuits being operatively coupled may mean that a direct or indirect connection between the circuits is established by wire or wirelessly so that a second circuit is controlled by a first circuit among the circuits. Although illustrated based on different blocks, an embodiment is not limited thereto, and a portion (e.g., the at least a portion of the processor 210, and the memory 215) of the circuits of FIG. 2 may be included in a single integrated circuit such as a system on a chip (SoC). A type and/or the number of circuits included in the electronic device 201 is not limited as illustrated in FIG. 2. For example, the electronic device 201 may include only a portion of the circuits illustrated in FIG. 2.

The processor 210 of the electronic device 201 according to an embodiment may include a circuit for processing data based on a plurality of instructions. The circuit for processing data may include, for example, an arithmetic and logic unit (ALU), a floating point unit (FPU), a field programmable gate array (FPGA), a central processing unit (CPU), and/or an application processor (AP). The number of the processors 210 may be one or more. The processor 210 may have a structure of a multi-core processor such as a dual core, a quad core, a hexa core, or an octa core. In the processor 210 having the structure of the multi-core processor, a function described with reference to the present disclosure may be collectively performed by different cores.

In an embodiment, the processor 210 may obtain parameters of a camera 130. For example, the processor 210 may obtain the parameters through calibration of the camera 130. For example, the parameters may include internal parameters such as a focal length, an angle of view f, a sensor size, and sensor resolution, and external parameters indicating a location and a direction of the camera 130.

According to an embodiment, the memory 215 of the electronic device 201 may include a hardware component for storing data and/or an instruction inputted and/or outputted to the processor 210. The memory 215 may include, for example, volatile memory, such as random-access memory (RAM), and/or non-volatile memory, such as read-only memory (ROM). The volatile memory may include, for example, at least one of dynamic RAM (DRAM), static RAM (SRAM), Cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, a solid state drive (SSD), and an embedded multimedia card (eMMC).

According to an embodiment, the sensor 220 of the electronic device 201 may generate electronic information that may be processed by the processor 210 and/or the memory 215 from non-electronic information related to a vehicle including the electronic device 201 and/or the electronic device 201. For example, the sensor 220 may include a global positioning system (GPS) sensor for detecting a geographic location of the electronic device 201. In addition to the GPS method, the sensor 220 may generate information indicating the geographic location of the electronic device 201 based on a global navigation satellite system (GNSS) such as Galileo and Beidou (compass). The information may be stored in the memory 215, processed by the processor 210, and/or transmitted to another electronic device distinguished from the electronic device 201 through the communication interface 225. The sensor 220 is not limited to the described above, and may include an image sensor for detecting an electromagnetic wave including light, an illumination sensor, an inertial measurement unit (IMU) (e.g., an acceleration sensor, a gyro sensor and/or a geomagnetic sensor), and/or a time-of-flight (ToF) sensor.

According to an embodiment, the communication interface 225 of the electronic device 201 may include a circuit, a port, and/or a connector for supporting communication with an external electronic device distinguished from the electronic device 201. For example, the communication interface 225 may include a port and/or a connector to support wired communication, such as a controller area network (CAN), a universal serial bus (USB), and/or a communication (COM) port. For example, the communication interface 225 may include a port and/or a connector based on an onboard diagnosis (OBD) standard. An embodiment is not limited thereto, and the communication interface 225 may include a circuit and/or an antenna for supporting wireless communication, such as a cellular mobile communication system, Wireless Fidelity (WIFI), Bluetooth, Bluetooth low energy (BLE), near field communication (NFC), satellite communication with a satellites located in Earth orbit, such as Low Earth Orbit (LEO), Geostationary Orbit (GEO), Medium Earth Orbit (MEO) and the like. The communication interface 225 may include a modem for generating an electrical signal according to a communication protocol.

Referring to FIG. 2, the electronic device 201 may be electrically and/or operatively connected to electronic components included in the vehicle through the communication interface 225. For example, the electronic device 201 may communicate with the camera 130 of the vehicle through the communication interface 225. Although an embodiment in which the electronic device 201 is directly connected to the camera 130 is described, an embodiment is not limited thereto, and the camera 130 may be indirectly connected to the electronic device 201 through an ECU of the vehicle.

In the memory 215 of the electronic device 201 according to an embodiment, one or more instructions (or commands) indicating an calculation and/or an operation to be performed on data by the processor 210 may be stored. A set of one or more instructions may be referred to as firmware, an operating system, a process, a routine, a sub-routine, a program, and/or a software application (hereinafter, an application). For example, when a set of a plurality of instructions distributed in a form of the operating system, the firmware, a driver, and/or the application is executed, the electronic device 201 and/or the processor 210 may perform at least one of operations described with reference to FIGS. 3A to 6. Hereinafter, an application being installed in the electronic device 201 may mean that one or more instructions provided in a form of the application are stored in the memory 215 of the electronic device 201, and that the one or more applications are stored in a format (e.g., a file having an extension designated by the operating system of the electronic device 201) executable by the processor 210 of the electronic device 201.

Hereinafter, a method of estimating a length of a trailer 120 and a method of estimating a distance from another vehicle located in a rear direction of the trailer 120 will be described. Operations described with reference to the following drawings may be performed by the electronic device 201 and/or the processor 210.

FIGS. 3A and 3B are diagrams for describing an operation of an electronic device for determining a length of a semi-trailer 120 according to an embodiment.

Referring to FIGS. 3A and 3B, a processor 210 may obtain an image 300 of a camera 130. For example, the processor 210 may obtain the image 300 of the camera 130 through a communication interface 225. The image 300 may be an image viewing toward a rear direction of a tractor 110 from below the semi-trailer 120.

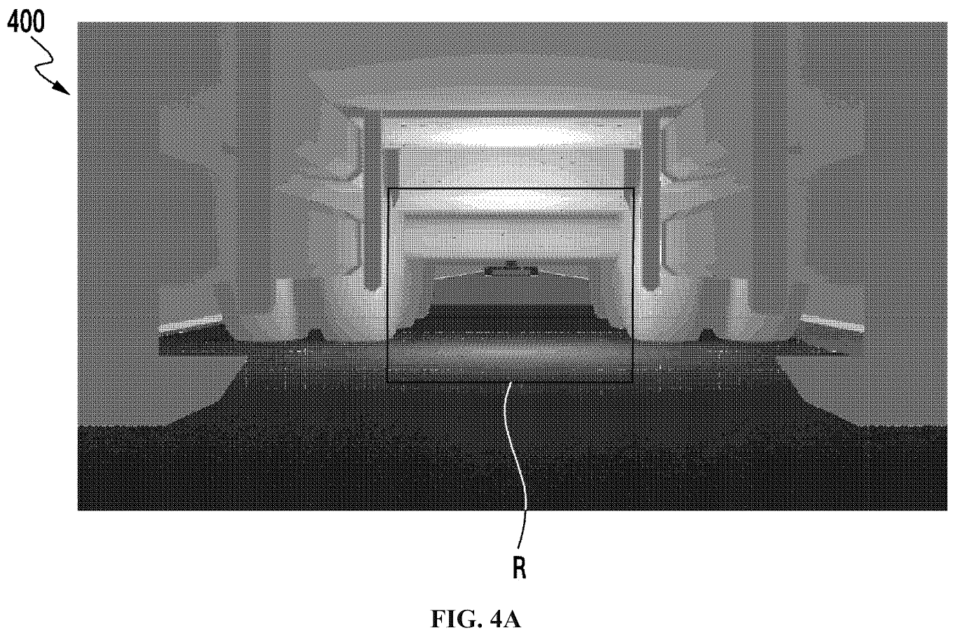

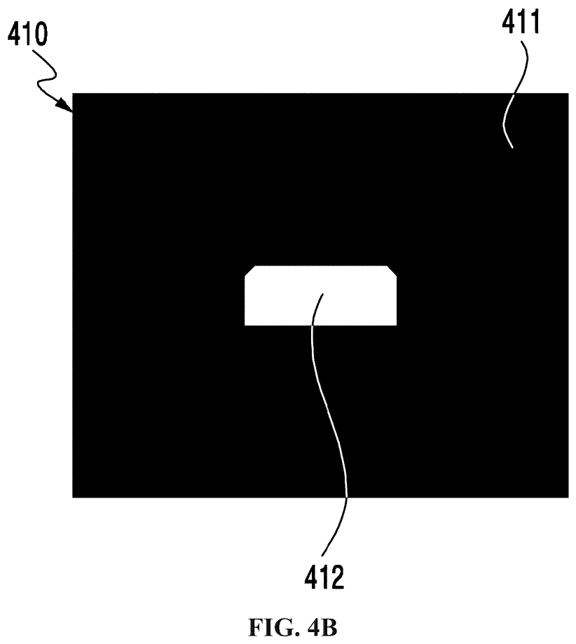

In an embodiment, the processor 210 may identify, within the image 300, a first portion 301 covered by the semi-trailer 120 and the second portion 302 not covered by the semi-trailer 120. The second portion 302 may be included in a region of interest (ROI) (e.g., ROI R of FIG. 4A) of the image 300. The second portion 302 may include a region between rearmost wheels of the semi-trailer 120 within the image 300. In an embodiment, the processor 210 may identify an actual size (e.g., an actual length d) of the second portion 302. An operation of the processor 210 identifying the first portion 301 and the second portion 302 within the image 300 and an operation of determining the actual size of the second portion 302 will be described in detail with reference to FIGS. 4A and 4B.

In an embodiment, the processor 210 may determine an actual length L of the semi-trailer 120 based on the actual size of the second portion 302. For example, the actual length L may be calculated by Equation 1 below.

$$L = d / tan ( a ) \qquad [ Equation 1 ]$$

In the Equation 1, an angle of view a may be an angle of view with respect to the second portion 302. For example, the angle of view a may be an angle of view with respect to a length dp of the second portion 302 according to a direction. The length dp of the second portion 302 may be a length within the image 300, not a length of an actual object.

In an embodiment, the processor 210 may calculate the angle of view a using an angle of view f of the camera 130, the length dp, and an entire length of the image 300 according to a direction parallel to the length dp (e.g., the angle of view f:the angle of view a=the entire length of the image 300:the length dp).

The semi-trailer 120 connected to the tractor 110 may generally vary in a size or a shape according to a transportation task. In an embodiment, a length of the semi-trailer 120 having various sizes may be easily determined by using the camera 130 installed on the tractor 110 other than the semi-trailer 120.

Referring to FIGS. 3A and 3B, an example of determining the actual length L of the semi-trailer 120 using the length dp according to the direction in the second portion 302 has been described, but is not limited thereto. For example, in order to determine the actual length L, a plurality of lengths may be used according to a plurality of directions within the second portion 302.

FIGS. 4A and 4B are diagrams for describing a method of determining a size of a second portion of an image, according to an embodiment. An image 400 illustrated in FIG. 4A may correspond to the image 300 of FIG. 3A.

Referring to FIG. 4A, a processor 210 may identify a region of interest (ROI) R within the image 400. The ROI R may be, for example, a region having the same center as the image 400 and having a size of 15% of the entire image 400, but is not limited thereto.

Referring to FIG. 4B together with FIG. 4A, in an embodiment, the processor 210 may obtain an image 410. For example, the processor 210 may obtain the image 410 in which a first portion 411 and a second portion 412 are distinguished by performing binarization processing (e.g., adaptive binarization) and a morphological operation on the ROI R of the image 400. In an embodiment, the first portion 411 of the image 410 may correspond to the first portion 301 of the image 300 of FIG. 3A, and the second portion 412 of the image 410 may correspond to the second portion 302 of the image 300 of FIG. 3A.

In an embodiment, the processor 210 may determine a size of the second portion 412 of the image 410. For example, the processor 210 may assign a median value of an area of pixels to pixels within the second portion 412 based on a horizontal direction of the image 410, and may determine the size (e.g., the length dp of FIG. 3A) of the second portion 412 based on this.

Alternatively or selectively, the processor 210 may obtain the size of the second portion 412 and/or an actual length L of a semi-trailer 120, using a neural network trained to analyze an image and/or a video. For example, the neural network may be trained by an image (or a video) according to a distance. For example, the neural network may include a deep neural network (DNN) having a plurality of layers of a neuron. For example, an object recognition algorithm based on deep learning, such as you only look once (YOLO), may be used. However, it is not limited by the above-described example. For example, neural network structures such as a single shot multi box detector (SSD), a region-based convolutional neural network (Faster R-CNN), and a Mask R-CNN may be used to drive the neural network.

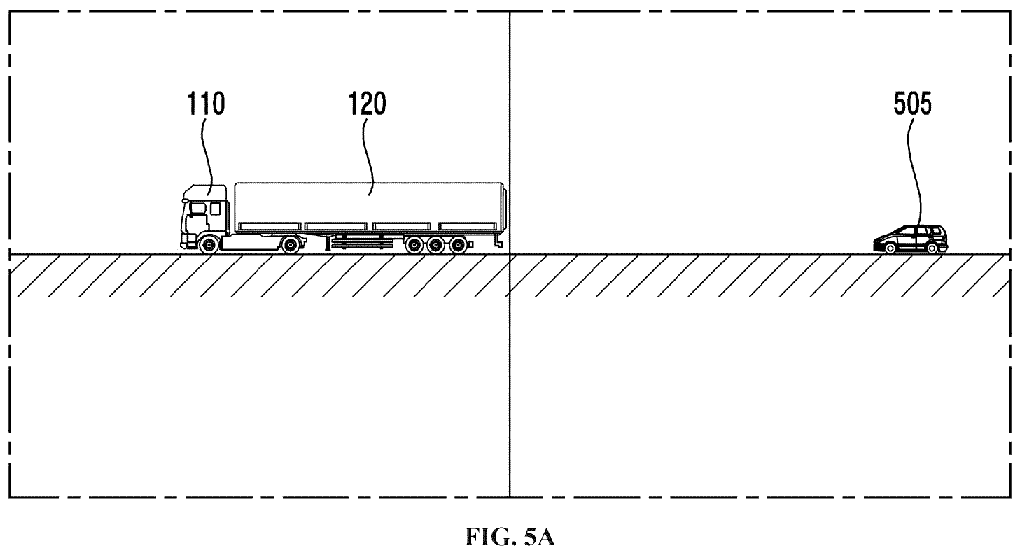

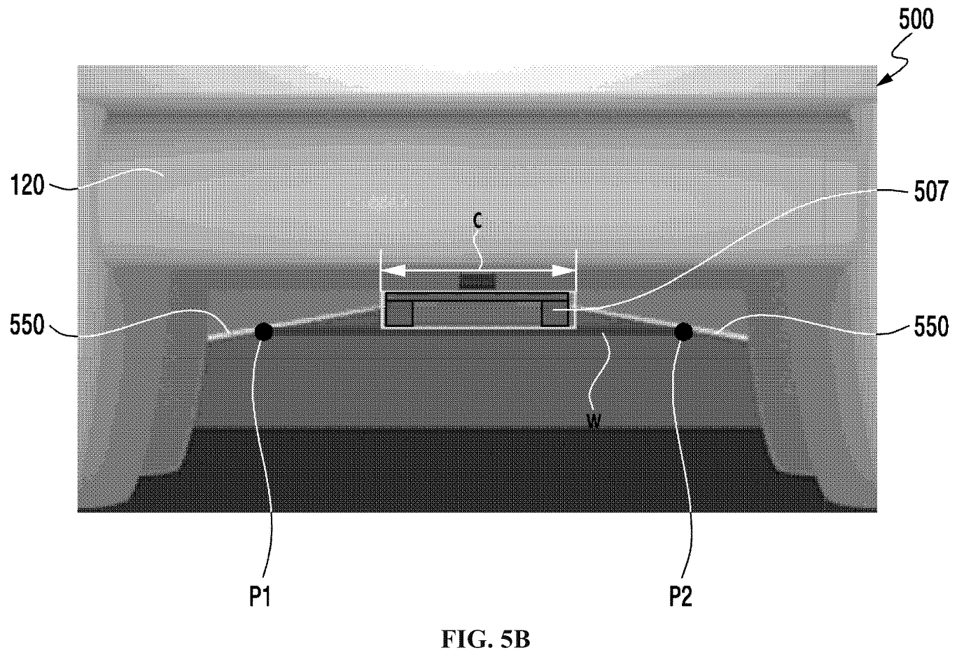

FIGS. 5A and 5B are diagrams for describing a method of determining a distance to another vehicle located in a rear direction of a vehicle according to an embodiment. FIG. 5A may be a lateral view of a vehicle and another vehicle 505 driving on a road viewed from a side. An image 500 may correspond to at least a portion of an image 300 obtained by a camera 130 of FIG. 5B.

Referring to FIGS. 5A and 5B, within the image 500, a processor 210 may identify an object 507 corresponding to the other vehicle 505 and determine a width c of the object 507 according to a horizontal direction of the image 500. For example, the processor 210 may identify the object 507 of the image 500 and determine the width c of the object 507 using a neural network trained to analyze the inside of the image. The object 507 may be included in the second portion 302 of the image 300 of FIG. 3A.

In an embodiment, within the image 500, the processor 210 may identify lanes 550 and determine a width w between the lanes 550. For example, the processor 210 may recognize the lanes 550 and determine the width w between the lanes 550 using the neural network trained to analyze the inside of the images. The width w may be a length according to a direction, parallel to the horizontal direction of the image 500 and contacting a lowermost end of an outer periphery of the object 507. Units of the width w and the width c may be the same (e.g., a pixel).

In an embodiment, the processor 210 may obtain information regarding an actual width between the lanes 550. For example, the processor 210 may detect a geographical location of the vehicle using a sensor 220 (e.g., a GPS sensor). The processor 210 may obtain the information regarding the actual width between the lanes 550 by using the detected geographical location. For example, in memory 215 of an electronic device 201, map data including information regarding an actual width of a lane may be stored to provide a navigation service, and the processor 210 may obtain the information regarding the actual width between the lanes 550 using the map data and the detected geographical location of the vehicle. For example, the processor 210 may obtain coordinates (e.g., a camera coordinate) of points P1 and P2 corresponding to both ends of the width w between the lanes 550. The processor 210 may convert the coordinates of the points P1 and P2 into points on a camera-based 3D coordinate system (or a world coordinate system) and may determine a distance between the points, by using the internal parameters and the external parameters of the camera 130 obtained through the camera calibration. Through this, the actual width between the lanes 550 may be determined. In order to improve accuracy of an actual width value between the lanes 550, the above-described method using the geographical location of the vehicle and the method using the coordinates of the points P1 and P2 may be used together (e.g., a case in which the vehicle is determined to be located on a flat ground). However, it is not limited thereto.

In an embodiment, the processor 210 may determine a front width of the other vehicle 505 corresponding to the width c based on information regarding the width c of the object 507, the width w between the lanes 550, and the actual width between the lanes 550 (e.g., the actual width between the lanes 550:the front width of the other vehicle 505=the width w between the lanes 550:the width c of the object 507).

In an embodiment, the processor 210 may determine an actual distance between the tractor 110 and the other vehicle 505 based on the front width of the other vehicle 505. For example, the processor 210 may determine the actual distance between the tractor 110 and the other vehicle 505 based on the front width of the other vehicle 505 and an angle of view f of the camera 130. In this regard, the method of calculating the actual length L of the semi-trailer 120 using the angle of view f and the actual length d of the second portion 302 described with reference to FIGS. 3A and 3B may be applied in a corresponding manner.

In an embodiment, a ratio of the width c of the object 507 of the other vehicle 505 and the width w between the lanes 550 may remain the same even when a distance between the vehicle and the other vehicle varies.

In an embodiment, the processor 210 may determine an actual distance between the semi-trailer 120 and the other vehicle 505 based on the actual length L of the semi-trailer 120 and the actual distance between the tractor 110 and the other vehicle 505 (e.g., the actual distance between the tractor 110 and the other vehicle 505−the actual length L of the semi-trailer 120=the actual distance between the semi-trailer 120 and the other vehicle 505).

In an embodiment, the processor 210 may determine a class of the other vehicle 505 based on the front width of the other vehicle 505 and/or the width c of the object 507. For example, the class may be a class classified according to a size of a vehicle, such as a large vehicle, a medium vehicle, or a small vehicle.

In case that the distances are the same, the width w between the lanes 550 may be the same, but the width c of the object 507 of the other vehicle 505 may be different according to the class of the vehicle. Accordingly, in order to determine the actual distance from the other vehicle 505, information regarding a class of the vehicle 505 may be used together.

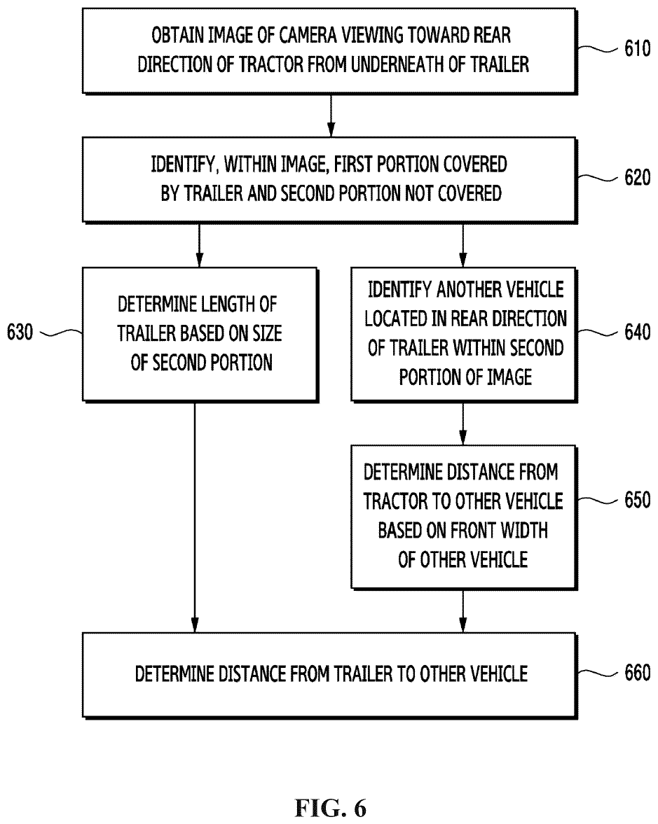

FIG. 6 illustrates a flowchart for an electronic device according to an embodiment. The electronic device 201 and/or the processor 210 of FIG. 2 may perform an operation of the electronic device described with reference to FIG. 6. For example, the processor 210 may cause the electronic device 201 to perform at least one of operations of FIG. 6, by executing instructions stored in memory 215. Each of the operations of FIG. 6 may be performed sequentially, but is not necessarily performed sequentially. For example, an order of each of the operations may be changed, and at least two operations may be performed in parallel.

Referring to FIG. 6, in an operation 610, the processor 210 may obtain an image 300 of a camera 130 viewing toward a rear direction of a tractor 110 from underneath of a semi-trailer 120. The rear direction may correspond to a direction in which the tractor 110 moves backward.

In an operation 620, the processor 210 may identify, within the image 300, a first portion 301 covered by the semi-trailer 120 and a second portion 302 not covered.

In an operation 630, the processor 210 may determine a length of the semi-trailer 120 based on a size of the second portion 302. Alternatively, the processor 210 may obtain information regarding the length of the semi-trailer 120 from the neural network to which the image 300 is inputted.

In an operation 640, the processor 210 may identify another vehicle 505 located in the rear direction of the semi-trailer 120 within the second portion 302 of the image 300. The operation 640 may be performed after performance of the operation 630, may be performed in parallel with the operation 630, or may be performed before performance of the operation 630.

In an operation 650, the processor 210 may determine a distance from the tractor 110 to the other vehicle 505 based on a front width of the other vehicle 505. Alternatively, the processor 210 may obtain information regarding the distance from tractor 110 to the other vehicle 505 from the neural network to which the image 300 is inputted.

In operation 660, the processor 210 may determine a distance from the semi-trailer 120 to the other vehicle 505. For example, the processor 210 may determine the distance from the semi-trailer 120 to the other vehicle 505 based on the length of the semi-trailer 120 and the distance between the tractor 110 and the other vehicle 505. Alternatively, the processor 210 may obtain information regarding the distance from the semi-trailer 120 to the other vehicle 505 from the neural network to which the image 300 is inputted.

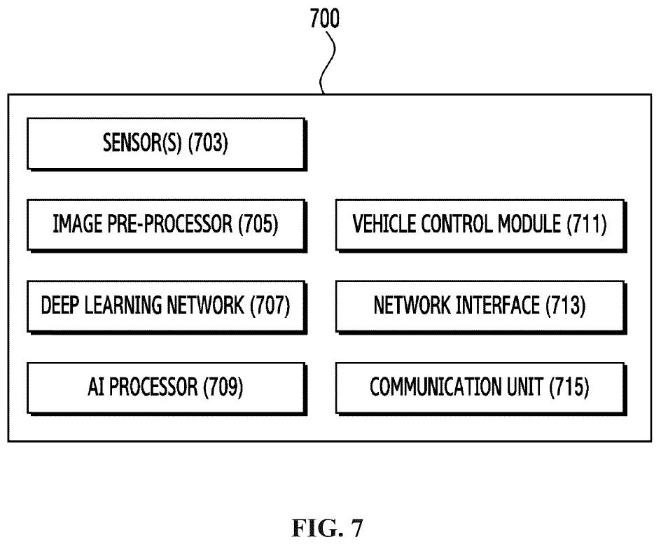

FIG. 7 illustrates an example of a block diagram illustrating an autonomous driving system of a vehicle according to an embodiment.

The autonomous driving system 700 of the vehicle according to FIG. 7 may be a deep learning network including sensors 703, an image pre-processor 705, a deep learning network 707, an artificial intelligence (AI) processor 709, a vehicle control module 711, a network interface 713, and a communication unit 715. In various embodiments, each element may be connected through various interfaces. For example, sensor data sensed and outputted by the sensors 703 may be fed to the image pre-processor 705. The sensor data processed by the image pre-processor 705 may be fed to the deep learning network 707 running on the AI processor 709. An output of the deep learning network 707 running by the AI processor 709 may be fed to the vehicle control module 711. Intermediate results of the deep learning network 707 running on the AI processor 707 may be fed to the AI processor 709. In various embodiments, the network interface 713 delivers autonomous driving route information and/or autonomous driving control commands for autonomous driving of the vehicle to internal block configurations, by performing communication with an electronic device (e.g., the electronic device 201 of FIG. 2) in the vehicle. In an embodiment, the network interface 713 may be used to transmit the sensor data obtained through the sensor(s) 703 to an external server. In some embodiments, the autonomous driving control system 700 may include additional or fewer components as appropriate. For example, in some embodiments, the image pre-processor 705 may be an optional component. For another example, a post-processing component (not illustrated) may be included in the autonomous driving control system 700 to perform post-processing on the output of the deep learning network 707 before the output is provided to the vehicle control module 711.

In some embodiments, the sensors 703 may include one or more sensors. In various embodiments, the sensors 703 may be attached to different locations of the vehicle. The sensors 703 may face one or more different directions. For example, the sensors 703 may be attached to a front, sides, a rear, and/or a roof of the vehicle to face directions such as forward-facing, rear-facing, and side-facing. In some embodiments, the sensors 703 may be image sensors such as high dynamic range cameras. In some embodiments, the sensors 703 include non-visual sensors. In some embodiments, the sensors 703 include RADAR, Light Detection And Ranging (LiDAR), and/or ultrasonic sensors in addition to an image sensor. In some embodiments, the sensors 703 are not mounted on a vehicle having the vehicle control module 711. For example, the sensors 703 may be included as a portion of a deep learning system for capturing the sensor data and may be attached to an environment or a roadway and/or mounted on nearby vehicles.

In some embodiments, the image pre-processor 705 may be used to pre-process the sensor data of the sensors 703. For example, the image pre-processor 705 may be used to preprocess the sensor data, to split the sensor data into one or more components, and/or to post-process one or more components. In some embodiments, the image pre-processor 705 may be a graphics processing unit (GPU), a central processing unit (CPU), an image signal processor, or a specialized image processor. In various embodiments, the image pre-processor 705 may be a tone-mapper processor for processing high dynamic range data. In some embodiments, the image pre-processor 705 may be a component of the AI processor 709.

In some embodiments, the deep learning network 707 may be a deep learning network for implementing control commands for controlling an autonomous vehicle. For example, the deep learning network 707 may be an artificial neural network such as a convolution neural network (CNN) trained by using the sensor data, and the output of the deep learning network 707 is provided to the vehicle control module 711.

In some embodiments, the artificial intelligence (AI) processor 709 may be a hardware processor for running the deep learning network 707. In some embodiments, the AI processor 709 is a specialized AI processor for performing inference on the sensor data through the convolution neural network (CNN). In some embodiments, the AI processor 709 may be optimized for a bit depth of the sensor data. In some embodiments, the AI processor 709 may be optimized for deep learning computations, such as computations of a neural network including a convolution, a dot product, a vector and/or matrix computations. In some embodiments, the AI processor 709 may be implemented through a plurality of graphics processing units (GPUs) capable of effectively performing parallel processing.

In various embodiments, the AI processor 709 may be coupled through an input/output interface to memory configured to perform a deep learning analysis on the sensor data received from the sensor(s) 703 while the AI processor 709 is running and to provide an AI processor having commands that cause to determine a machine learning result used to operate the vehicle at least partially autonomously. In some embodiments, the vehicle control module 711 may be used to process commands for vehicle control outputted from the artificial intelligence (AI) processor 709 and translate the output of the AI processor 709 into commands for controlling a module of each vehicle to control various modules of the vehicle. In some embodiments, the vehicle control module 711 is used to control a vehicle for autonomous driving. In some embodiments, the vehicle control module 711 may adjust steering and/or speed of the vehicle. For example, the vehicle control module 711 may be used to control driving of the vehicle such as deceleration, acceleration, steering, lane change, lane keeping, and the like. In some embodiments, the vehicle control module 711 may generate control signals for controlling vehicle lighting, such as brake lights, turns signals, headlights, and the like. In some embodiments, the vehicle control module 711 may be used to control vehicle audio-related systems such as a vehicle's sound system, vehicle's audio warnings, a vehicle's microphone system, a vehicle's horn system, and the like.

In some embodiments, the vehicle control module 711 may be used to control notification systems, including warning systems to notify passengers and/or a driver of driving events, such as approach of an intended destination or a potential collision. In some embodiments, the vehicle control module 711 may be used to adjust sensors, such as the sensors 703 of the vehicle. For example, the vehicle control module 711 may modify the orientation of the sensors 703, change output resolution and/or a format type of the sensors 703, increase or decrease the capture rate, adjust a dynamic range, and adjust a focus of the camera. In addition, the vehicle control module 711 may turn on/off the operation of sensors individually or collectively.

In some embodiments, the vehicle control module 711 may be used to change parameters of the image pre-processor 705 in a method such as modifying a frequency range of filters, adjusting features and/or edge detection parameters for object detection, or adjusting channels and a bit depth, and the like. In various embodiments, the vehicle control module 711 may be used to control autonomous driving of the vehicle and/or a driver assistance function of the vehicle.

In some embodiments, the network interface 713 may be responsible for an internal interface between block configurations of the autonomous driving control system 700 and the communication unit 715. Specifically, the network interface 713 may be a communication interface for receiving and/or transmitting data including voice data. According to various embodiments, the network interface 713 may be connected to external servers to connect voice calls, receive and/or transmit text messages, transmit sensor data, update software of the vehicle to the autonomous driving system, or update software of the autonomous driving system of the vehicle, through the communication unit 715.

In various embodiments, the communication unit 715 may include various wireless interfaces of cellular or WiFi methods. For example, the network interface 713 may be used to receive an update on operating parameters and/or commands for the sensors 703, the image pre-processor 705, the deep learning network 707, the AI processor 709, and the vehicle control module 711 from an external server connected through the communication unit 715. For example, a machine learning model of the deep learning network 707 may be updated by using the communication unit 715. According to another example, the communication unit 715 may be used to update operating parameters of the image pre-processor 705, such as image processing parameters, and/or firmware of the sensors 703.

In another embodiment, the communication unit 715 may be used to activate communications for an emergency contact and emergency services in an accident or near-accident event. For example, in a crash event, the communication unit 715 may be used to call emergency services for assistance and may be used to externally notify emergency services of crash details and a location of the vehicle. In various embodiments, the communication unit 715 may update or obtain an expected arrival time and/or a destination location.

According to an embodiment, the autonomous driving system 700 illustrated in FIG. 7 may be configured with an electronic device 101 of the vehicle. According to an embodiment, when an autonomous driving release event occurs from a user during autonomous driving of the vehicle, the AI processor 709 of the autonomous driving system 700 may control the software of the vehicle autonomous driving to learn by controlling information related to the autonomous driving release event to be inputted as training set data of the deep learning network.

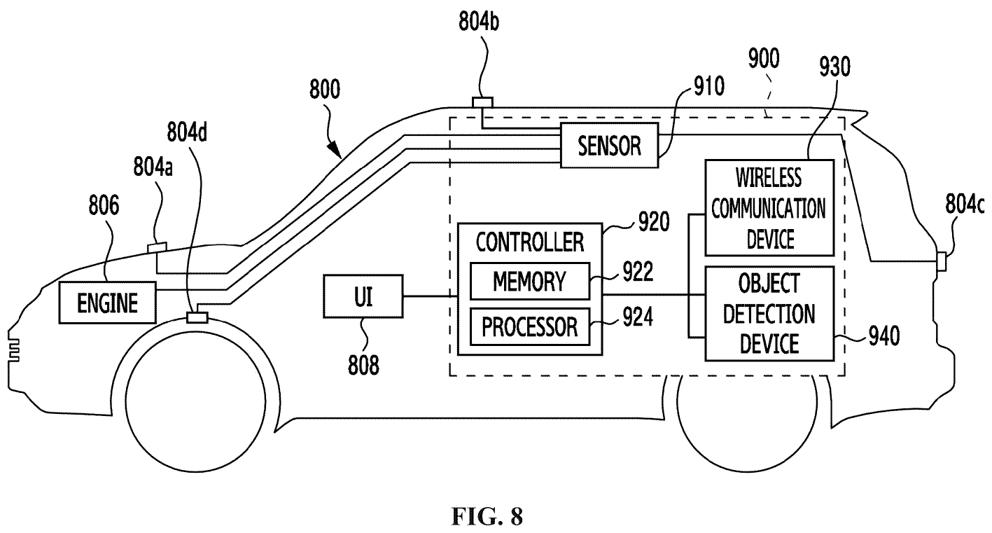

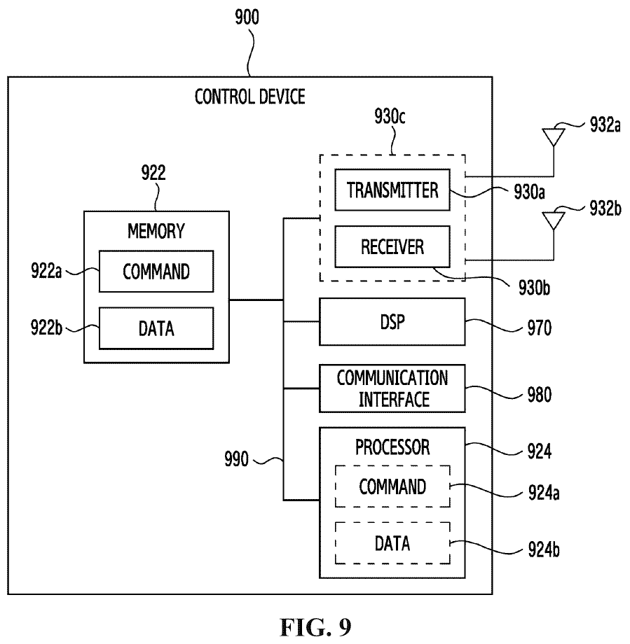

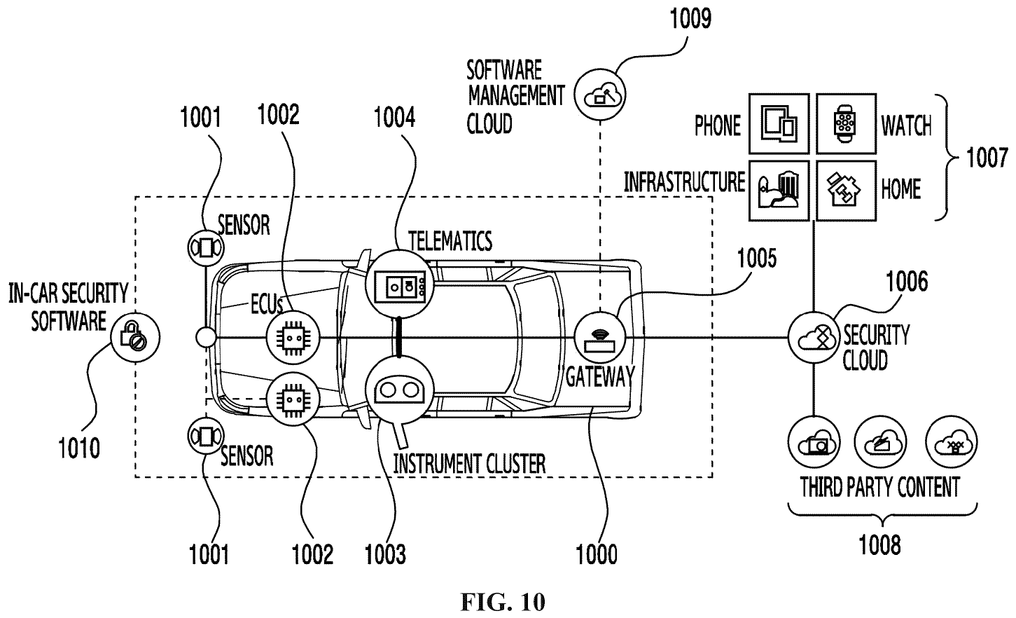

FIGS. 8 and 9 illustrate an example of a block diagram illustrating an autonomous driving moving object according to an embodiment. FIG. 10 illustrates an example of a gateway associated with a user device according to various embodiments.

Referring to FIG. 8, an autonomous moving object 800 according to the present embodiment may include a control device 900, sensing modules 804a, 804b, 804c, and 804d, an engine 806, and a user interface 808.

The autonomous driving moving object 800 may have an autonomous driving mode or a manual mode. As an example, according to a user input received through the user interface 808, it may be switched from the manual mode to the autonomous driving mode or may be switched from the autonomous driving mode to the manual mode.

In case that the moving object 800 operates in the autonomous driving mode, the autonomous driving moving object 800 may operate under control of the control device 900.

In the present embodiment, the control device 900 may include a controller 920, including memory 922 and a processor 924, a sensor 910, a communication device 930, and an object detection device 940.

Herein, the object detection device 940 may perform all or a portion of a function of a distance measurement device.

That is, in the present embodiment, the object detection device 940 is a device for detecting an object located outside the moving object 800, and the object detection device 940 may detect the object located outside the moving object 800 and may generate object information according to the detection result.

The object information may include information on existence or nonexistence of the object, location information of the object, distance information between the moving object and the object, and relative speed information between the moving object and the object.

The object may include various objects located outside the moving object 800, such as a lane, another vehicle, a pedestrian, a traffic signal, light, a road, a structure, a speed bump, a landform, an animal, and the like. Herein, the traffic signal may be a concept including a traffic signal, a traffic sign, a pattern or text drawn on a road surface. In addition, the light may be light generated from a lamp equipped in another vehicle, light generated from a streetlamp, or sunlight.

In addition, the structure may be an object located around a road and fixed to the ground. For example, the structure may include a streetlamp, a street tree, a building, a power pole, a traffic light, and a bridge. The landform may include a mountain, a hill, and the like.

Such the object detection device 940 may include a camera module. The controller 920 may extract object information from an external image photographed by the camera module and enable the controller 920 to process information thereon.

In addition, the object detection device 940 may further include imaging devices for recognizing an external environment. RADAR, a GPS device, Odometry, and another computer vision device, an ultrasonic sensor, and an infrared sensor may be used, in addition to LIDAR, and these devices may be selected or operated simultaneously as needed to enable more precise detection.

Meanwhile, the distance measurement device according to an embodiment of the present invention may calculate a distance between the autonomous driving moving object 800 and the object and may control an operation of the moving object based on the distance calculated in connection with the control device 900 of the autonomous driving moving object 800.

As an example, in case that there is a possibility of a collision according to the distance between the autonomous driving moving object 800 and the object, the autonomous driving moving object 800 may control a brake to lower speed or stop. As another example, in case that the object is a moving object, the autonomous driving moving object 800 may control driving speed of the autonomous driving moving object 800 to maintain a predetermined distance or more from the object.

This distance measurement device according to an embodiment of the present invention may be configured as a module in the control device 900 of the autonomous driving moving object 800. That is, the memory 922 and the processor 924 of the control device 900 may be configured to implement a collision prevention method according to the present invention in software.

In addition, the sensor 910 may obtain various sensing information by connecting an internal/external environment of the moving object with the sensing modules 804a, 804b, 804c, and 804d. Herein, the sensor 910 may include a posture sensor (e.g., a yaw sensor), a roll sensor, a pitch sensor, a collision sensor, a wheel sensor, a speed sensor, a tilt sensor, a weight detection sensor, a heading sensor, a gyro sensor, a position module, a moving object forward/rearward sensor, a battery sensor, a fuel sensor, a tire sensor, a steering sensor by handle rotation, a moving object internal temperature sensor, a moving object internal humidity sensor, an ultrasonic sensor, an illumination sensor, an accelerator pedal position sensor, a brake pedal position sensor, and the like.

Accordingly, the sensor 910 may obtain sensing signals for moving object posture information, moving object collision information, moving object direction information, moving object location information (GPS information), moving object angle information, and moving object speed information, moving object acceleration information, moving object tilt information, moving object forward/rearward information, battery information, fuel information, tire information, moving object lamp information, and moving object internal temperature information, moving object internal humidity information, a steering wheel rotation angle, moving object external illumination, a pressure applied to an accelerator pedal, a pressure applied to a brake pedal, and the like.

In addition, the sensor 910 may further include an accelerator pedal sensor, a pressure sensor, an engine speed sensor, an air flow sensor (AFS), an intake air temperature sensor (ATS), a water temperature sensor (WTS), a throttle position sensor (TPS), a TDC sensor, a crank angle sensor (CAS), and the like.

As described above, the sensor 910 may generate moving object state information based on sensing data.

The wireless communication device 930 is configured to implement wireless communication between the autonomous driving moving object 800. For example, it enables the autonomous driving moving object 800 to communicate with a mobile phone of a user, or the other wireless communication device 930, another moving object, a central device (a traffic control device), a server, and the like. The wireless communication device 930 may transmit and receive a wireless signal according to an access wireless protocol. A wireless communication protocol may be Wi-Fi, Bluetooth, Long-Term Evolution (LTE), Code Division Multiple Access (CDMA), Wideband Code Division Multiple Access (WCDMA), Global Systems for Mobile Communications (GSM), but the communication protocol is not limited thereto.

In addition, in the present embodiment, it is also possible for the autonomous driving moving object 800 to implement communication between moving objects through the wireless communication device 930. That is, the wireless communication device 930 may perform communication with another moving object and other moving objects on the road through vehicle-to-vehicle (V2V) communication. The autonomous driving moving object 800 may transmit and receive information such as driving warning and traffic information through the vehicle-to-vehicle (V2V) communication, and it is also possible to request information from or receive a request from another moving object. For example, the wireless communication device 930 may perform the V2V communication as a dedicated short-range communication (DSRC) device or a Cellular-V2V (C-V2V) device. In addition, besides the vehicle-to-vehicle (V2V) communication, communication (e.g., Vehicle to Everything communication (V2X)) between a vehicle and another object (e.g., an electronic device carried by a pedestrian, and the like) may also be implemented through the wireless communication device 930.

In addition, the wireless communication device 930 may obtain information generated from various mobilities, including infrastructure (a traffic light, a CCTV, a RSU, a eNode B, and the like) located on a road or other autonomous driving/non-autonomous driving vehicles, and the like, through a non-terrestrial network other than a terrestrial network, as information for autonomous driving performance of the autonomous driving moving object 800.

For example, the wireless communication device 930 may perform wireless communication through a Low Earth Orbit (LEO) satellite system, a Medium Earth Orbit (MEO) satellite system, a Geostationary Orbit (GEO) satellite system, a High Altitude Platform (HAP) system, and the like, that configure a non-terrestrial network and an antenna dedicated to the non-terrestrial network mounted on the autonomous driving moving object 800.

For example, the wireless communication device 930 may perform wireless communication with various platforms configuring the NTN according to a 5TH Generation New Radio Non-Terrestrial Network (5G NR NTN) standard, which is currently discussed in 3GPP, and the like, but is not limited thereto.

In the present embodiment, the controller 920 may select a platform that may properly perform NTN communication in consideration of various information such as a location, current time, and available power of the autonomous driving moving object 800, and control the wireless communication device 930 to perform wireless communication with the selected platform.

In the present embodiment, the controller 920, which is a unit that controls an overall operation of each unit in the moving object 800, may be configured by a manufacturer of the moving object when manufacturing or may be additionally configured to perform a function of autonomous driving after manufacturing. In addition, a configuration for performing a continuous additional function may be included through an upgrade of the controller 920 configured when manufacturing. This controller 920 may also be named an Electronic Control Unit (ECU).

The controller 920 may collect various data from the connected sensor 910, the object detection device 940, the communication device 930, and may transmit a control signal to the sensor 910, the engine 806, the user interface 808, the communication device 930, and the object detection device 940 included in other components in the moving object based on the collected data. In addition, although not illustrated, the control signal may also be transmitted to an acceleration device, a braking system, a steering device, or a navigation device related to driving of the moving object.

In the present embodiment, the controller 920 may control the engine 806, for example, may detects a speed limit of a road on which the autonomous driving moving object 800 is driving, and may control the engine 806 so that driving speed does not exceed the speed limit or may control the engine 806 to accelerate the driving speed of the autonomous driving moving object 800 within a range that does not exceed the speed limit.

In addition, when the autonomous driving moving object 800 approaches a lane or deviates from the lane while the autonomous driving moving object 800 is driving, the controller 920 may determine whether such lane approaching and deviating are due to a normal driving situation or another driving situation, and may control the engine 806 to control the driving of the moving object according to the determination result. Specifically, the autonomous driving moving object 800 may detect lanes formed on both sides of the lane on which the moving object is driving. In this case, the controller 920 may determine whether the autonomous driving moving object 800 approaches the lane or deviates from the lane, and if it is determined that the autonomous driving moving object 800 approaches the lane or deviates from the lane, the controller 920 may determine whether this driving is according to an accurate driving situation or another driving situation. Herein, as an example of the normal driving situation, it may be a situation in which a lane change of the moving object is required. In addition, as an example of the other driving situations, it may be a situation in which a lane change of the moving object is not required. When it is determined that the autonomous driving moving object 800 is approaching the lane or deviating from the lane in a situation in which the moving object does not need to change lane, the controller 920 may control the driving of the autonomous driving moving object 800 so that the autonomous driving moving object 800 does not deviate from the lane and normally drives in the corresponding vehicle.

In case that another moving object or an obstacle exists in a front of the moving object, it may control the engine 906 or the braking system to decelerate the driving moving object, and may control a trajectory, a driving route, and a steering angle in addition to speed. Alternatively, the controller 920 may control the driving of the moving object by generating a necessary control signal according to recognition information of another external environment, such as a driving lane or a driving signal of the moving object.

In addition to generating its own control signal, the controller 920 may also control the driving of the moving object by performing communication with a nearby moving object or a central server and transmitting a command to control peripheral devices through received information.

In addition, since accurate recognition of the moving object or lane according to the present embodiment may be difficult in case that a location of the camera module changes or an angle of view changes, the controller 920 may generate a control signal for controlling to perform calibration of the camera module to prevent this. Therefore, in the present embodiment, by generating the calibration control signal to the camera module, the controller 920 may continuously maintain a normal mounting location, a direction, an angle of view, and the like of the camera module even when a mounting location of the camera module is changed due to vibration or impact generated by a movement of the autonomous driving moving object 800. In case that an initial mounting location, a direction, and an angle of view information of the camera module that are pre-stored and an initial mounting location, a direction, an angle of view information, and the like of the camera module measured while the autonomous driving moving object 800 is driving are changed by a threshold value or more, the controller 920 may generate the control signal to perform the calibration of the camera module.

In the present embodiment, the controller 920 may include the memory 922 and the processor 924. The processor 924 may execute software stored in the memory 922 according to the control signal of the controller 920. Specifically, the controller 920 may store data and commands for performing the lane detection method according to the present invention in the memory 922, and the commands may be executed by the processor 924 to implement one or more methods disclosed herein.

In this case, the memory 922 may be stored in a recording medium executable by the non-volatile processor 924. The memory 922 may store software and data through an appropriate internal/external device. The memory 922 may be configured with random access memory (RAM), read only memory (ROM), a hard disk, and a memory 922 device connected to a dongle.

The memory 922 may at least store an Operating system (OS), a user application, and executable commands. The memory 922 may also store application data and array data structures.

The processor 924, which is a microprocessor or an appropriate electronic processor, may be a controller, a microcontroller, or a state machine.

The processor 924 may be implemented as a combination of computing devices, and the computing device may be configured with a digital signal processor, a microprocessor, or an appropriate combination thereof.

Meanwhile, the autonomous driving moving object 800 may further include the user interface 808 for a user input with respect to the above-described control device 900. The user interface 808 may enable a user to input information with appropriate interaction. For example, it may be implemented as a touch screen, a keypad, or an operation button, and the like. The user interface 808 may transmit an input or a command to the controller 920, and the controller 920 may perform a control operation of the moving object in response to the input or the command.

In addition, the user interface 808, which is a device outside the autonomous driving moving object 800, may perform communication with the autonomous driving moving object 800 through the wireless communication device 930. For example, the user interface 808 may be linkable with a mobile phone, a tablet, or another computer device.

Furthermore, in the present embodiment, the autonomous driving moving object 800 has been described as including the engine 806, but it may also include another type of a propulsion system. For example, the moving object may be operated with electrical energy, and may be operated through hydrogen energy or a hybrid system combining them. Therefore, the controller 920 may include a propulsion mechanism according to the propulsion system of the autonomous driving moving object 800 and may provide a control signal according to this to components of each propulsion mechanism.

Hereinafter, a detailed configuration of the control device 900 according to the present invention according to the present embodiment will be described in more detail with reference to FIG. 10.

A control device 900 includes a processor 924. The processor 924, may be a general-purpose single or multi-chip microprocessor, a dedicated microprocessor, a microcontroller, a programmable gate array, and the like. The processor may be referred to as a central processing unit (CPU). In addition, in the present embodiment, it is possible that the processor 924 is used as a combination of a plurality of processors.

The control device 900 also includes memory 922. The memory 922 may be any electronic component capable of storing electronic information. The memory 922 may also include a combination of the memories 922 in addition to single memory.

Data and commands 922a for performing a distance measuring method of a distance measuring device according to the present invention may be stored in the memory 922. When the processor 924 executes the commands 922a, all or a portion of the commands 922a and the data 922b required for performing a command may be loaded 924a and 924b onto the processor 924.

The control device 900 may include a transmitter 930a, a receiver 930b, or a transceiver 930c for permitting transmission and reception of signals. One or more antennas 932a and 932b may be electrically connected to the transmitter 930a, the receiver 930b, or each transceiver 930c, and may further include antennas.

The control device 900 may include a digital signal processor (DSP) 970. Through the DSP 970, the digital signal may be quickly processed by a moving object.

The control device 900 may include a communication interface 980. The communication interface 980 may include one or more ports and/or communication modules for connecting other devices to the control device 900. The communication interface 980 may enable a user and the control device 900 to interact with each other.

Various configurations of the control device 900 may be connected together by one or more buses 990, and the buses 990 may include a power bus, a control signal bus, a state signal bus, a data bus, and the like. Under a control of the processor 924, the configurations may transmit mutual information through the bus 990 and perform a desired function.

Meanwhile, in various embodiments, the control device 900 may be related to a gateway for communication with a security cloud. For example, referring to FIG. 10, the control device 900 may be related to a gateway 1005 for providing information obtained from at least one of components 1001 to 1004 of a vehicle 1000 to a security cloud 1006. For example, the gateway 1005 may be included in the control device 900. For another example, the gateway 1005 may be configured as a separate device in the vehicle 1000 that is distinguished from the control device 900. The gateway 1005 connects a network in the vehicle 1000 secured by a software management cloud 1009, the security cloud 1006, and in-car security software 1010, having different networks, to enable communication.

For example, a component 1001 may be a sensor. For example, the sensor may be used to obtain information on at least one of a state of the vehicle 1000 or a state around the vehicle 1000. For example, the component 1001 may include a sensor 910.

For example, a component 1002 may be electronic control units (ECUs). For example, the ECUs may be used for engine control, transmission control, airbag control, and tire pressure management.

For example, a component 1003 may be an instrument cluster. For example, the instrument cluster may mean a panel located in a front of a driver's seat among dashboards. For example, the instrument cluster may be configured to display information necessary for driving to a driver (or a passenger). For example, the instrument cluster may be used to display at least one of visual elements for indicating a revolutions per minute (or rotates per minute) (RPM) of the engine, visual elements for indicating speed of the vehicle 1000, visual elements for indicating an amount of remaining fuel, visual elements for indicating a state of a gear, or visual elements for indicating information obtained through the component 1001.

For example, a component 1004 may be a telematics device. For example, the telematics device may mean a device that provides various mobile communication services such as location information and safe driving in the vehicle 1000 by coupling wireless communication technology and global positioning system (GPS) technology. For example, the telematics device may be used to connect the vehicle 1000 with a driver, a cloud (e.g., the security cloud 1006), and/or a surrounding environment. For example, the telematics device may be configured to support high bandwidth and low latency for 5G NR-standard technology (e.g., V2X technology of the 5G NR, Non-Terrestrial Network (NTN) technology of the 5G NR). For example, the telematics device may be configured to support autonomous driving of the vehicle 1000.

For example, the gateway 1005 may be used to connect a network within the vehicle 1000, and the software management cloud 1009 and the secure cloud 1006, which are a network outside the vehicle. For example, the software management cloud 1009 may be used to update or manage at least one software necessary for driving and managing the vehicle 1000. For example, the software management cloud 1009 may be linked to the in-car security software 1010 installed in the vehicle. For example, the in-car security software 1010 may be used to provide a security function in the vehicle 1000. For example, the in-car security software 1010 may encrypt data transmitted and received through an in-car network using an encryption key obtained from an external authorized server for encryption of the in-car network. In various embodiments, the encryption key used by the in-car security software 1010 may be generated corresponding to vehicle identification information (a vehicle license plate, a vehicle identification number (VIN)) or information (e.g., user identification information) uniquely assigned to each user.

In various embodiments, the gateway 1005 may transmit data encrypted by the in-car security software 1010 based on the encryption key to the software management cloud 1009 and/or the security cloud 1006. The software management cloud 1009 and/or the security cloud 1006 may identify the data received from which vehicle or which user by decrypting the data encrypted by the encryption key of the in-car security software 1010. For example, since the decryption key is a unique key corresponding to the encryption key, the software management cloud 1009 and/or the security cloud 1006 may identify a transmission entity (e.g., the vehicle or the user) of the data based on the data decrypted through the decryption key.

For example, the gateway 1005 may be configured to support in-car security software 1010 and may be related to the control device 900. For example, the gateway 1005 may be related to the control device 900 to support a connection between a client device 1007 and the control device 900 connected to the security cloud 1006. For another example, the gateway 1005 may be related to the control device 900 to support a connection between a third-party cloud 1008 connected to the security cloud 1006 and the control device 900. However, it is not limited thereto.

In various embodiments, the gateway 1005 may be used to connect the vehicle 1000 with the software management cloud 1009 to manage operating software of the vehicle 1000. For example, the software management cloud 1009 may monitor whether updating the operating software of the vehicle 1000 is required, and based on monitoring that the updating the operating software of the vehicle 1000 is required, provide data for the updating the operating software of the vehicle 1000 through the gateway 1005. For another example, the software management cloud 1009 may receive a user request for updating the operating software of the vehicle 1000 from the vehicle 1000 through the gateway 1005, and provide data for updating the operating software of the vehicle 1000 based on the reception. However, it is not limited thereto.

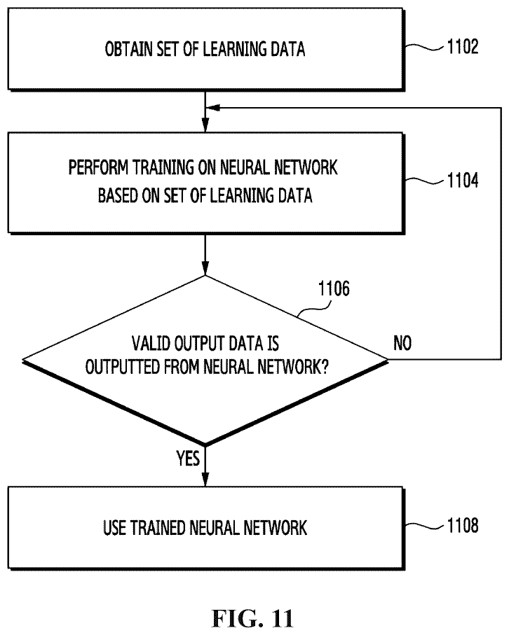

FIG. 11 is a diagram for describing an operation of an electronic device for training a neural network based on a set of learning data according to an embodiment.

An operation described with reference to FIG. 11 may be performed by the above-described electronic device (e.g., the electronic device 201 of FIG. 2).

Referring to FIG. 11, in an operation 1102, the electronic device may obtain the set of the learning data according to an embodiment. The electronic device may obtain the set of the learning data for supervised learning. The learning data may include a pair of input data and ground truth data corresponding to the input data. The ground truth data may indicate output data to be obtained from the neural network that has received the input data, which is the pair of the ground truth data. The ground truth data may be obtained by the electronic device described above.

For example, in case of training the neural network for image recognition, the learning data may include information regarding an image and one or more subjects included within the image. The information may include a category (or a class) of a subject identifiable through the image. The information may include a location, a width, a height, and/or a size of a visual object corresponding to the subject within the image. The set of the learning data identified through the operation 1102 may include pairs of a plurality of learning data. Within the example of training the neural network for the image recognition, the set of the learning data identified by the electronic device may include a plurality of images and ground truth data corresponding to each of the plurality of images.

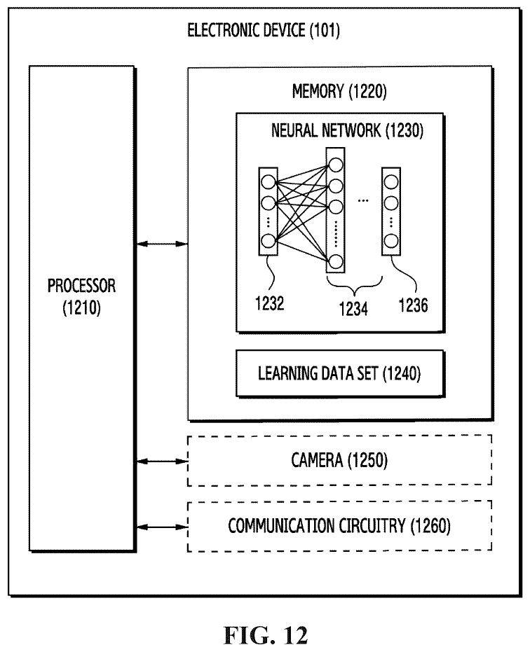

Referring to FIG. 11, in an operation 1104, the electronic device according to an embodiment may perform training on the neural network based on the set of the learning data. In an embodiment in which the neural network is trained based on the supervised learning, the electronic device may input the input data included in the learning data to an input layer of the neural network. An example of the neural network including the input layer will be described with reference to FIG. 12. From an output layer of the neural network receiving the input data through the input layer, the electronic device may obtain output data of the neural network corresponding to the input data.

In an embodiment, the training of the operation 1104 may be performed based on a difference between the output data and the ground truth data included in the learning data and corresponding to the input data. For example, the electronic device may adjust one or more parameters related to the neural network (e.g., a weight to be described later with reference to FIG. 12) to reduce the difference based on a gradient descent algorithm. An operation of the electronic device adjusting the one or more parameters may be referred to as tuning for the neural network. The electronic device may perform tuning of the neural network based on the output data using a function defined to evaluate performance of the neural network, such as a cost function. The difference between the output data and the ground truth data may be included as an example of the cost function.

Referring to FIG. 11, in an operation 1106, according to an embodiment, the electronic device may identify whether valid output data is outputted from the neural network trained by the operation 1104. The output data being valid may mean that the difference (or the cost function) between the output data and the ground truth data satisfies a condition set for use of the neural network. For example, in case that an average value and/or a maximum value of the difference between the output data and the ground truth data is less than or equal to a designated threshold value, the electronic device may determine that the valid output data is outputted from the neural network.

In case that the valid output data is not outputted from the neural network (1106-No), the electronic device may repeatedly perform training of the neural network based on the operation 1104. An embodiment is not limited thereto, and the electronic device may repeatedly perform the operations 1102 and 1104.

In a state in which the valid output data is obtained from the neural network (1106-Yes), based on an operation 1108, the electronic device according to an embodiment may use the trained neural network. For example, the electronic device may input other input data to the neural network that is distinct from the input data inputted to the neural network as the learning data. The electronic device may use output data obtained from the neural network receiving the other input data as a result of performing inference on the other input data based on the neural network.

FIG. 12 is a block diagram of an electronic device according to an embodiment.

An electronic device 101 of FIG. 12 may include the above-described electronic device.

For example, an operation described with reference to FIG. 12 may be performed by the electronic device 101 of FIG. 12 and/or a processor 1210 of FIG. 12.

Referring to FIG. 12, the processor 1210 of the electronic device 101 may perform computations related to a neural network 1230 stored in memory 1220. The processor 1210 may include at least one of a center processing unit (CPU), a graphic processing unit (GPU), and a neural processing unit (NPU). The NPU may be implemented as a chip separated from the CPU, or integrated into a chip such as the CPU in a form of a system on a chip (SoC). The NPU integrated into the CPU may be referred to as a neural core and/or an artificial intelligence (AI) accelerator.

Referring to FIG. 12, the processor 1210 may identify the neural network 1230 stored in the memory 1220. The neural network 1230 may include a combination of an input layer 1232, one or more hidden layers 1234 (or intermediate layers), and an output layer 1236. The above-described layers (e.g., the input layer 1232, the one or more hidden layers 1234, and the output layer 1236) may include a plurality of nodes. The number of hidden layers 1234 may vary according to an embodiment, and the neural network 1230 including the plurality of hidden layers 1234 may be referred to as a deep neural network. An operation of training the deep neural network may be referred to as deep learning.

In an embodiment, in case that the neural network 1230 has a structure of a feed forward neural network, a first node included in a specific layer may be connected to all of second nodes included in another layer before the specific layer. In the memory 1220, parameters stored for the neural network 1230 may include weights assigned to connections between the second nodes and the first node. In the neural network 1230 having the structure of the feed forward neural network, a value of the first node may correspond to a weighted sum of values assigned to the second nodes, based on the weights assigned to the connections connecting the second nodes and the first node.

In an embodiment, in case that the neural network 1230 has a structure of a convolutional neural network, the first node included in the specific layer may correspond to a weighted sum of a portion of the second nodes included in the other layer before the specific layer. The portion of the second nodes corresponding to the first node may be identified by a filter corresponding to the specific layer. In the memory 1220, the parameters stored for the neural network 1230 may include weights indicating the filter. The filter may include, among the second nodes, one or more nodes to be used to calculate a weighted sum of the first node, and weights corresponding to each of the one or more nodes.

According to an embodiment, the processor 1210 of the electronic device 101 may perform training on the neural network 1230 using a learning data set 1240 stored in the memory 1220. Based on the learning data set 1240, the processor 1210 may adjust one or more parameters stored in the memory 1220 for the neural network 1230 by performing the operation described with reference to FIG. 11.

According to an embodiment, the processor 1210 of the electronic device 101 may perform object detection, object recognition, and/or object classification using the neural network 1230 trained based on the learning data set 1240. The processor 1210 may input an image (or a video) obtained through a camera 1250 into the input layer 1232 of the neural network 1230. Based on the input layer 1232 to which the image is inputted, the processor 1210 may obtain a set (e.g., the output data) of values of the nodes of the output layer 1236 by sequentially obtaining values of the nodes of the layers included in the neural network 1230. The output data may be used as a result of inferring information included in the image using the neural network 1230. An embodiment is not limited thereto, and the processor 1210 may input an image (or a video) obtained from an external electronic device connected to the electronic device 101 through communication circuitry 1260 to the neural network 1230.

In an embodiment, the neural network 1230 trained to process an image may be used to identify a region corresponding to a subject within the image (object detection), and/or to identify the class of the subject represented within the image (object recognition and/or object classification). For example, the electronic device 101 may segment the region corresponding to the subject within the image based on a quadrangle shape such as a bounding box using the neural network 1230. For example, the electronic device 101 may identify at least one class matching the subject among a plurality of designated classes using the neural network 1230.

In an embodiment, an electronic device of a vehicle including a tractor for towing a trailer may comprise a communication interface, and a processor, and the processor may be configured to obtain, through the communication interface, an image of a camera viewing toward a rear direction of the tractor from underneath the trailer, wherein the camera is disposed at a rear portion of the tractor, identify, within the image, a first portion covered by the trailer and a second portion not covered by the trailer, and based on a size of the second portion, determine a length of the trailer.

In an embodiment, the processor may be configured to determine the length of the trailer based on the size of the second portion and an angle of view of the camera.

In an embodiment, the processor may be configured to identify the first portion and the second portion by performing a binarization operation and a morphological operation on the image.

In an embodiment, the processor may be configured to determine the size of the second portion using an area assigned to pixels of the identified second portion.

In an embodiment, the processor may be configured to determine the size of the second portion and/or the length of the trailer using a neural network trained to analyze a video.

In an embodiment, the processor may be configured to identify, within the second portion of the image, another vehicle located in the rear direction of the trailer, and determine a distance to the another vehicle based on a front width of the another vehicle.

In an embodiment, the processor may be configured to determine the distance to the another vehicle based on the front width of the another vehicle and an angle of view of the camera.

In an embodiment, the processor may be configured to determine a distance between the trailer and the another vehicle based on a length of the trailer and the distance to the another vehicle.

In an embodiment, the processor may be configured to identify, within the second portion of the image, the another vehicle and a lane, determine a first width of the another vehicle and a second width of the lane, and determine the front width of the another vehicle based on information regarding an actual width of the lane, the width of the another vehicle, the first width of the lane, and the second width of the lane.

In an embodiment, the electronic device may comprise a global positioning system (GPS) sensor, and the processor may be configured to detect a geographical location of the vehicle using the GPS sensor, and obtain the information regarding the actual width of the lane using the detected geographical location.

In an embodiment, the processor may be configured to obtain coordinate information for both end points of the second width of the lane within the second portion of the image, and obtain information regarding the actual width of the lane based on the coordinate information.

In an embodiment, the processor may be configured to determine a class of the another vehicle based on the front width of the another vehicle, wherein the class is a class according to a size of a vehicle, and determine the distance to the another vehicle based on the angle of view of the camera, the front width of the another vehicle, and the class of the another vehicle.

According to an embodiment, a method of an electronic device of a vehicle including a tractor for towing a trailer may comprise obtaining an image of a camera viewing toward a rear direction of the tractor from underneath the trailer, wherein the camera is disposed at a rear portion of the tractor, identifying, within the image, a first portion covered by the trailer and a second portion not covered by the trailer, and based on a size of the second portion, determining a length of the trailer.

In an embodiment, the method may comprise determining the length of the trailer based on the size of the second portion and an angle of view of the camera.

In an embodiment, the method may comprise identifying the first portion and the second portion by performing a binarization operation and a morphological operation on the image.

In an embodiment, the method may comprise determining the size of the second portion using an area assigned to pixels of the identified second portion.

In an embodiment, the method may comprise determining the size of the second portion and/or the length of the trailer using a neural network trained to analyze a video.

In an embodiment, the method may comprise identifying, within the second portion of the image, another vehicle located in the rear direction of the trailer, and determining a distance to the another vehicle based on a front width of the another vehicle.

In an embodiment, the method may comprise determining the distance to the another vehicle based on the front width of the another vehicle and an angle of view of the camera, and determining a distance between the trailer and the another vehicle based on a length of the trailer and the distance to the another vehicle.

According to an embodiment, a non-transitory computer-readable storage medium may store one or more programs. The one or more programs, when executed by a processor of an electronic device of a vehicle including a tractor for towing a trailer, may cause the electronic device to obtain an image of a camera viewing toward a rear direction of the tractor from underneath the trailer, wherein the camera is disposed at a rear portion of the tractor, identify, within the image, a first portion covered by the trailer and a second portion not covered by the trailer, and based on a size of the second portion, determine a length of the trailer.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

What is claimed is:

1. An electronic device of a vehicle including a tractor for towing a trailer, comprising:
a communication interface; and
a processor, wherein the processor is configured to:
obtain, through the communication interface, an image of a camera viewing toward a rear direction of the tractor from underneath the trailer, wherein the camera is disposed at a rear portion of the tractor;
identify, within the image, a first portion covered by the trailer and a second portion not covered by the trailer; and
based on a size of the second portion, determine a length of the trailer.

2. The electronic device of claim 1,
wherein the processor is configured to:
determine the length of the trailer based on the size of the second portion and an angle of view of the camera.

3. The electronic device of claim 1,
wherein the processor is configured to:
identify the first portion and the second portion by performing a binarization operation and a morphological operation on the image.

4. The electronic device of claim 3,
wherein the processor is configured to:
determine the size of the second portion using an area assigned to pixels of the identified second portion.

5. The electronic device of claim 1,
wherein the processor is configured to:
determine the size of the second portion and/or the length of the trailer using a neural network trained to analyze a video.

6. The electronic device of claim 1,
wherein the processor is configured to:
identify, within the second portion of the image, another vehicle located in the rear direction of the trailer; and
determine a distance to the another vehicle based on a front width of the another vehicle.

7. The electronic device of claim 6,
wherein the processor is configured to:
determine the distance to the another vehicle based on the front width of the another vehicle and an angle of view of the camera.

8. The electronic device of claim 6,
wherein the processor is configured to:
determine a distance between the trailer and the another vehicle based on a length of the trailer and the distance to the another vehicle.

9. The electronic device of claim 6,
wherein the processor is configured to:
identify, within the second portion of the image, the another vehicle and a lane;
determine a first width of the another vehicle and a second width of the lane; and
determine the front width of the another vehicle based on the first width of the another vehicle, the second width of the lane, and information regarding an actual width of the lane.

10. The electronic device of claim 9, comprising a global positioning system (GPS) sensor, and
wherein the processor is configured to:
detect a geographical location of the vehicle using the GPS sensor; and
obtain the information regarding the actual width of the lane using the detected geographical location.

11. The electronic device of claim 9,
wherein the processor is configured to:
obtain coordinate information for both end points of the second width of the lane within the second portion of the image; and
obtain information regarding the actual width of the lane based on the coordinate information.

12. The electronic device of claim 7,
wherein the processor is configured to:
determine a class of the another vehicle based on the front width of the another vehicle, wherein the class is a class according to a size of a vehicle; and
determine the distance to the another vehicle based on the angle of view of the camera, the front width of the another vehicle, and the class of the another vehicle.

13. A method of an electronic device of a vehicle including a tractor for towing a trailer, comprising:
obtaining an image of a camera viewing toward a rear direction of the tractor from underneath the trailer, wherein the camera is disposed at a rear portion of the tractor;
identifying, within the image, a first portion covered by the trailer and a second portion not covered by the trailer; and
based on a size of the second portion, determining a length of the trailer.

14. The method of claim 13, comprising:
determining the length of the trailer based on the size of the second portion and an angle of view of the camera.

15. The method of claim 13, comprising:
identifying the first portion and the second portion by performing a binarization operation and a morphological operation on the image.

16. The method of claim 15, comprising:
determining the size of the second portion using an area assigned to pixels of the identified second portion.

17. The method of claim 13, comprising:
determining the size of the second portion and/or the length of the trailer using a neural network trained to analyze a video.

18. The method of claim 13, comprising:
identifying, within the second portion of the image, another vehicle located in the rear direction of the trailer; and
determining a distance to the another vehicle based on a front width of the another vehicle.

19. The method of claim 18, comprising:
determining the distance to the another vehicle based on the front width of the another vehicle and an angle of view of the camera; and
determining a distance between the trailer and the another vehicle based on a length of the trailer and the distance to the another vehicle.

20. A non-transitory computer-readable storage medium storing one or more programs,
wherein the one or more programs, when executed by a processor of an electronic device of a vehicle including a tractor for towing a trailer, cause the electronic device to:
obtain an image of a camera viewing toward a rear direction of the tractor from underneath the trailer, wherein the camera is disposed at a rear portion of the tractor;
identify, within the image, a first portion covered by the trailer and a second portion not covered by the trailer; and
based on a size of the second portion, determine a length of the trailer.
